(19) United States
(12) Patent Application Publication
(10) Pub. No.: US 2007/0277379 A1
(43) Pub. Date: Dec. 6, 2007

(54) Rotary electric shaver

(75) Inventor: Masaki Okabe, Matsumoto (JP)

Correspondence Address: QUINN EMANUEL;KODA & ANDROLIA, 865 S. FIGUEROA STREET, 10TH FLOOR, LOS ANGELES, CA, 90017, US

(73) Assignee: IZUMI PRODUCTS COMPANY

(21) Appl. No.: 11/807,988

(22) Filed: May 31, 2007

(30) Foreign Application Priority Data
May 31, 2006 (JP) 2006-151662

(51) Int. Cl. B26B 19/14

(52) U.S. Cl. 30/43.92; 30/346.51

(57) ABSTRACT

A rotary electric shaver including an outer cutter frame mounted on a shaver main body housing a motor therein, outer cutters held in an outer cutter mounting hole formed in this outer cutter frame the upper surfaces thereof providing skin contacting surfaces, and inner cutters that rotate while being pressed against the inner surfaces of the outer cutters and have cutter bodies for cutting hair entering hair introduction openings formed in the outer cutters; wherein the outer cutters are provided tiltable relative to the outer cutter frame, and the outer cutter frame is tiltable relative to the shaver main body.

### BACKGROUND OF THE INVENTION

1. Field of the Invention

The present invention relates to an electric shaver and more particularly to a rotary electric shaver.

2. Description of the Related Art

Generally, in an electric rotary shaver, the outer surface of a ring-shaped top face (shaving portion), which is a thin layer portion, of an outer cutter(s) makes a skin contacting surface, and the inner cutter(s) that rotates while sliding against the inner surface of this shaving portion from below cut(s) whiskers (hair) advancing into hair introduction openings formed in the shaving portion of the outer cutter(s). In this type of electric shaver, hair introduction openings are formed in the thin shaving portion of the outer cutter so that they cross in substantially the radial direction, thus being substantially in the shape of slits of a certain width. In this structure, it is possible to make the outer cutter closely contact the curved surface of the skin being shaved by way of providing the outer cutter in a tiltable manner, thus enhancing the shaving feel. In such a rotary type shaver as this, two or three outer cutters are typically mounted in a holder (outer cutter frame).

In such an electric shaver having two or three outer cutters, in order to enhance the tightness of the contact between the outer cutters and the skin, it is necessary to make the angle by which the outer cutters are allowed to tilt larger. If, however, the range of tilting of the outer cutters only is made larger, when the outer cutters tilt at the maximum, the circumferential edges of the outer cutters will strike the skin sharply, allowing the pressure of contact on the skin to become larger. As a result, problems arise that the skin is pressed into the hair introduction openings, causing deep shaving and skin damage, and further causing a burning sensation in the skin after the shaving.

In Japanese Patent Application National Publication (Kohyo) No. H09-503424, in order to eliminate such problems, it is proposed that a skin support rim that surrounds the outer circumferences of the outer cutters be interposed between the outer cutters and the holder, and this skin support rim be divided for each outer cutter or coupled so as to be bendable, so that the respective portions of the skin support rim be made tiltable relative to the outer cutters and holder, either independently or linked together. One example thereof is a structure in which a pair of projections (support members) that protrude outward in the outer radial direction are provided in the skin support rim surrounding each outer cutter, and these projections are engaged in the inner circumferential surfaces of the outer cutter mounting holes of the holder.

However, this structure has problems. Since tiltable skin support rims are provided between the holder and the outer cutters, a large number of precision parts are required for the shaver head, and thus it is inevitable that the structure becomes complex.

On the other hand, there is a shaver that includes outer cutters provided directly in a holder (outer cutter frame) without using skin support rims. FIGS. 8(a) through 8(d) show the shaver head of such a conventional shaver. FIG. 8(a) is a top view thereof, and FIGS. 8(b) to 8(d) are views seen from point a in FIG. 8(a). FIG. 8(b) illustrates the normal condition of the outer cutters, and the tilted conditions of the outer cutters are shown in FIGS. 8(c) and 8(d). FIGS. 9(a) and 9(b) show the skin pressed in the vicinity of the center of the outer surface of the shaver head, and FIGS. 10(a) and 10(b) show the skin pressed in the vicinity of the periphery of the outer surface of the shaver head.

In FIGS. 8(a) through 8(d), the reference numeral 1 refers to a shaver head, 2 an outer cutter frame (outer cutter holder), and 3 outer cutters. The outer cutter frame 2 is secured to the upper surface of a shaver main body (not shown) that has a motor therein. In the outer cutter frame 2, three outer cutter mounting holes 4 are formed at, respectively, the positions of the apexes of an equilateral triangle, and outer cutters 3 are respectively installed in the outer cutter mounting holes 4 from below. More specifically, each one of the outer cutter 3 is shaped substantially as a shallow cylinder with the top closed, having radially formed hair introduction openings (slits) 5 formed in the circular top face (shaving portion) thereof (see FIG. 8(a)), while the open end thereof is formed with a flange bent in the outer circumferential direction, so that the flange engages the outer cutter mounting hole 4 of the outer cutter frame 2 from below.

Against the inner surfaces (lower surfaces) of the circular shaving (top) portions of the outer cutters 3, inner cutters (not shown) are pressed from below by springs and are rotated by the motor. In other words, a drive shaft, which is rotationally driven by the motor installed inside the shaver main body and to which an upward oriented return propensity is imparted, is engaged with each one of the inner cutters. The inner cutters are thus pressed against the inner surfaces of shaving portions of the outer cutters 3 by the upward oriented return force (upward pushing force) of the drive shaft; and thus, the outer cutters 3 can be pushed down inside the outer cutter mounting hole 4, and they also can tilt.

When a convex portion of the skin 6 comes into contact with the outer cutter frame 2 as seen from FIG. 8(c), the outer cutters 3 tilt toward the inside to a maximum angle β1. When, on the other hand, a concave portion of the skin 6 comes in to contact with the outer cutter frame 2 as shown in FIG. 8(d), the outer cutters 3 tilt toward the outside to a maximum angle β2.

When a convex portion and a concave portion of the skin 6 come into contact with the outer cutter frame 2 substantially evenly, the skin 6 contacts the area X indicated by diagonal hatching lines in FIG. 8(a). In other words, the skin 6 comes into contact with the area X on the upper surface of the outer cutter frame 2 excluding the outer cutter mounting holes 4. For this reason, the contact pressure with which the skin 6 contacts the outer cutters 3 will not become excessive, and deep shaving can be prevented.

When the curvature of the convex portion of the skin 6 is small, the skin 6 contacts only in the vicinity of the center of the outer cutter frame 2 as seen from FIGS. 9(a) and 9(b). The diagonally hatched portion Y in FIG. 9(b) indicates the area of the skin 6 to which the shaver comes into contact during shaving. Conversely, when the curvature (in the opposite direction) of a concave portion of the skin 6 is small, the skin contacts only on the outer circumferential side of the outer cutter frame 2 as illustrated by diagonally hatched lines in FIG. 10(b). In other words, the diagonally hatched portions Z in FIG. 11(b) indicate areas of the skin 6 to which the shaver comes into contact in this situation.

As seen from the above, when the curvature of the convex portion or concave portion of the skin 6 is small, the contact areas Y and Z become small, as shown in FIG. 9(b) and FIG. 10(b), the use efficiency of the outer cutters 3 lowers, the shaving efficiency declines, and the shaving feel deteriorates.

### BRIEF SUMMARY OF THE INVENTION

Accordingly, the object of the present invention, which is devised in view of such circumstances as described above, is to provide a rotary electric shaver which is suitable for implementing small shaver head size without involving complex structure, and with which it is possible to enhance the outer cutter utilization efficiency, and enhance the shaving feel when, in particular, the curvature of concave or convex portions of the skin is small.

The above object is accomplished by a unique structure of the present invention for a rotary electric shaver that includes:
a shaver main body housing therein a motor,
an outer cutter frame mounted on the shaver main body,
an outer cutter(s) provided in an outer cutter mounting hole(s) formed in the outer cutter frame, an outer surface of the outer cutter providing a skin contacting surface, and
an inner cutter(s) that rotates while being pressed against an inner surface of the outer cutter(s) and has cutter bodies for cutting hair entering hair introduction openings formed in the outer cutter; and

in the present invention, the outer cutter(s) is provided so as to be tiltable relative to the outer cutter frame, and the outer cutter frame is provided so as to be tiltable relative to the shaver main body.

In the present invention, as seen from the above, the outer cutter(s) can tilt relative to the outer cutter frame, and this outer cutter frame can also tilt relative to the shaver main body. Accordingly, the shaver has an even greater maximum angle to which the outer cutter(s) tilts relative to the shaver main body. As a result, the outer cutter(s) have expanded contact surface areas relative to the skin; and thus the outer cutter utilization efficiency is high, and enhanced shaving feel is provided. It is also possible to prevent deep shaving, since the angle of tilt of the outer cutter(s) relative to the outer cutter frame is prevented from becoming excessive. Furthermore, because the outer cutter frame itself tilts relative to the shaver main body, complex structure can be avoided, and the shaver head is well suited to being made smaller.

In the present invention, when a plurality of outer cutters are provided in the outer cutter frame, a corresponding number of outer cuter mounting holes are formed in the outer cutter frame, and bend-allowing portions or means are provided between the adjacent outer cutter mounting holes, so that the bend-allowing means allow portions of the outer cutter frame surrounding the outer cutters tilt either independently or together with other portions. The bend-allowing means can be slits that are cut from the outer circumference of the outer cutter frame toward the center of the outer cutter frame.

Three outer cutters can be provided at equal intervals in the circumferential direction in the outer cutter frame; and in this structure, the outer cutter frame is provided with three slits provided at equal angles of 120° apart, and the outer cutter frame is attached to said shaver main body at three circumferential portions of the outer cutter frame that are between adjacent two slits. In addition, in this structure, the center part of the outer cutter frame is formed so as to be depressible.

In the present invention, for instance, such a structure can be employed that
outer circumferential lower portions of the outer cutter frame which are between adjacent slits are made in contact with the shaver main body so as to make support points, and
projections arising from the shaver main body side and near the support points are engaged with the outer circumferential inner surface of the outer cutter frame. In the outer cutter frame of the present invention, three outer cutters are typically provided at equal intervals in the circumferential direction; however, one or two outer cutters can be provided, and more than three outer cutters can also be provided.

In the present invention, the outer cutter(s) is tiltable relative to the outer cutter frame. However, the outer cutter(s) can also be provided so as to be both tiltable and depressible. With the tiltable and depressible outer cutter(s), the movable range of the outer cutter(s) increases even further, and the advantages of the present invention increases even further.

Moreover, in the present invention, an outer cutter upward pushing spring load can be set to be smaller than an outer cutter frame upward pushing spring load. In this structure, when the skin is pressed against the shaver, the outer cutter(s) will first either tilt or depressed, and then the outer cutter frame will tilt. Thus, setting the spring force is made easy. The outer cutter upward pushing spring load can be set by a drive shaft return spring; and the outer cutter frame upward pushing force can be set by the springiness which the outer cutter frame itself has and by an upward pushing spring that elastically supports the inner cutter holder. An upwardly oriented return propensity is constantly imparted to the outer cutter(s) by the outer cutter upward pushing force, and, in conjunction therewith, an upwardly oriented spring load is applied to the outer cutter frame as well.

In the present invention, the outer cutter frame bends every time the tilt angle changes; as a result, when a bending force is repeatedly applied to the outer cutter frame, there is a danger that damages develop in the bending portion(s) due to fatigue, deteriorating the durability. Accordingly, in the present invention, a flat spring having a plurality of erected portions that respectively erect on the horizontally outer sides of the outer cutter mounting holes of the outer cutter frame is provided in the outer cutter frame.

### BRIEF DESCRIPTION OF THE SEVERAL VIEWS OF THE DRAWINGS

FIG. 1 is front view of the rotary electric shaver according to one embodiment of the present invention;

FIG. 2 is a vertical cross-sectional view of the shaver head of the shaver of the present invention;

FIG. 3 is a vertical cross-sectional view of one cutter unit of the shaver of the present invention, comprising an outer cutter and an inner cutter, combined;

FIG. 4(a) is a top view of the outer cutter frame used in the shaver of the present invention, FIGS. 4(b) through 4(d) being side elevation views thereof;

FIG. 5(a) is a top view of the outer cutter frame combined with outer cutters, FIGS. 5(b) through 5(g) being side elevation views thereof;

FIG. 6(a) is a top view of the outer cutter frame of another embodiment of the present invention, FIG. 6(b) being a side elevation view thereof, FIG. 6(c) being a bottom view thereof, FIG. 6(d) being a top view of the spring used in the outer cutter frame of FIG. 6(a), and FIG. 6(e) being a side elevation view of the spring;

FIG. 7(a) is a top view of the outer cutter frame of still another embodiment of the present invention, FIG. 7(b) being a side elevation view thereof, FIG. 7(c) being a bottom view thereof, FIG. 7(d) being a top view of the spring used in the outer cutter frame of FIG. 7(a), and FIG. 7(e) being a side elevation view of the spring;

FIG. 8(a) is a top view of a shaver head of a conventional rotary shaver, FIGS. 8(b) through 8(d) being side views thereof;

FIGS. 9(a) and 9(b) illustrate the shaver head of a conventional rotary shaver in use; and

FIGS. 10(a) and 10(b) illustrate the shaver head of a conventional rotary shaver in use.

### DETAILED DESCRIPTION OF THE INVENTION

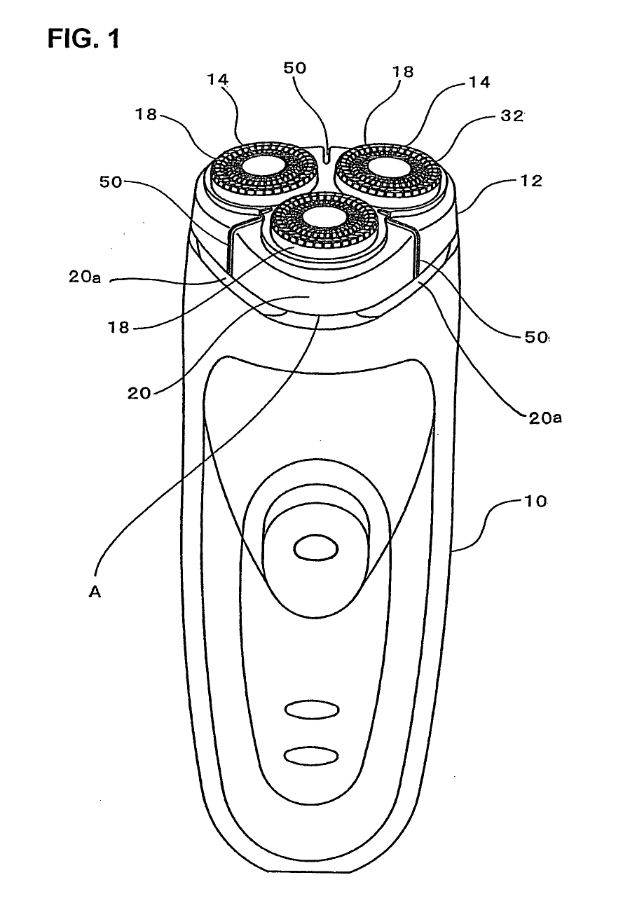

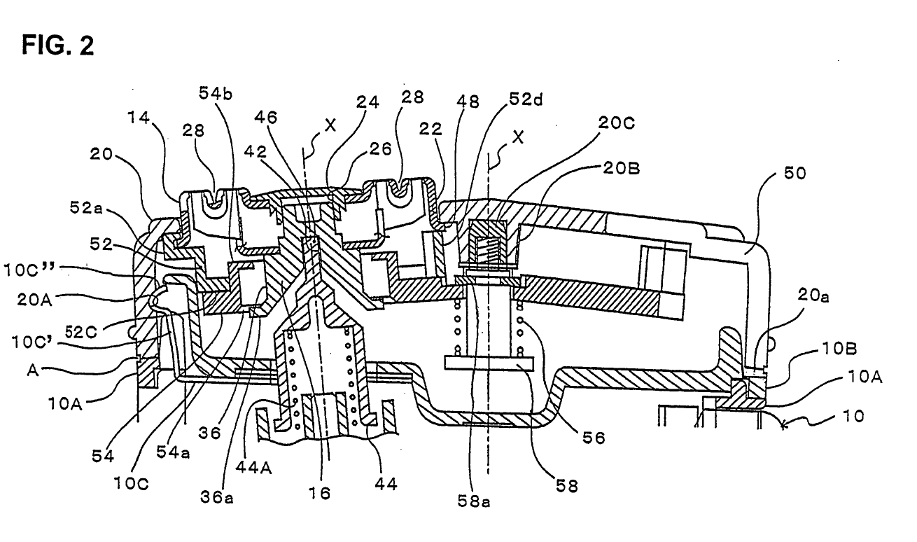

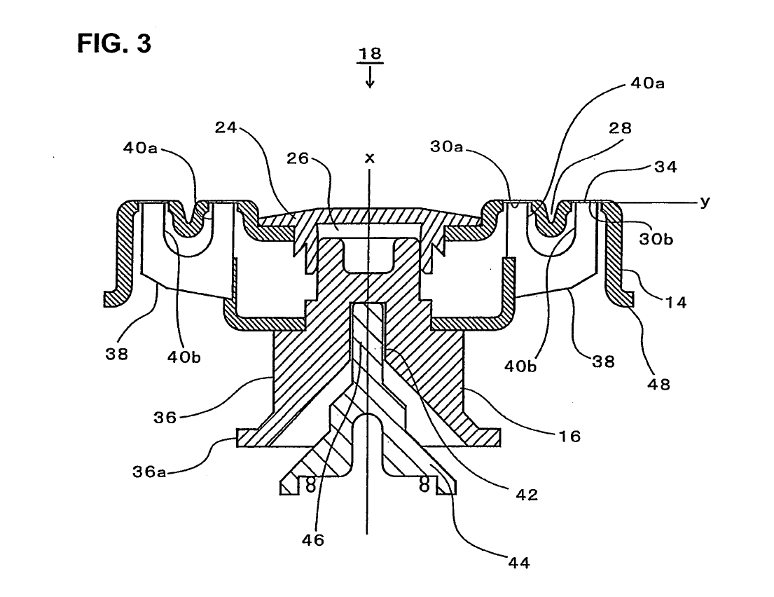

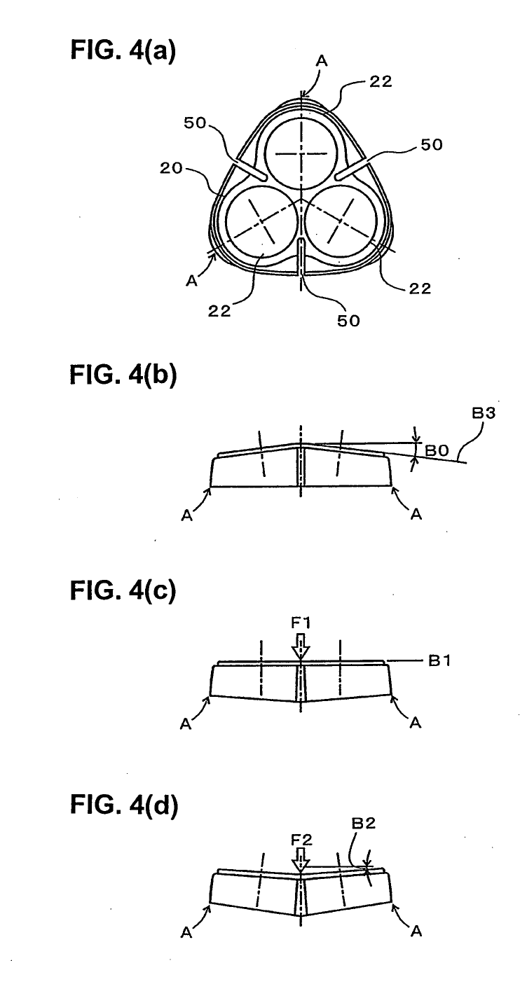

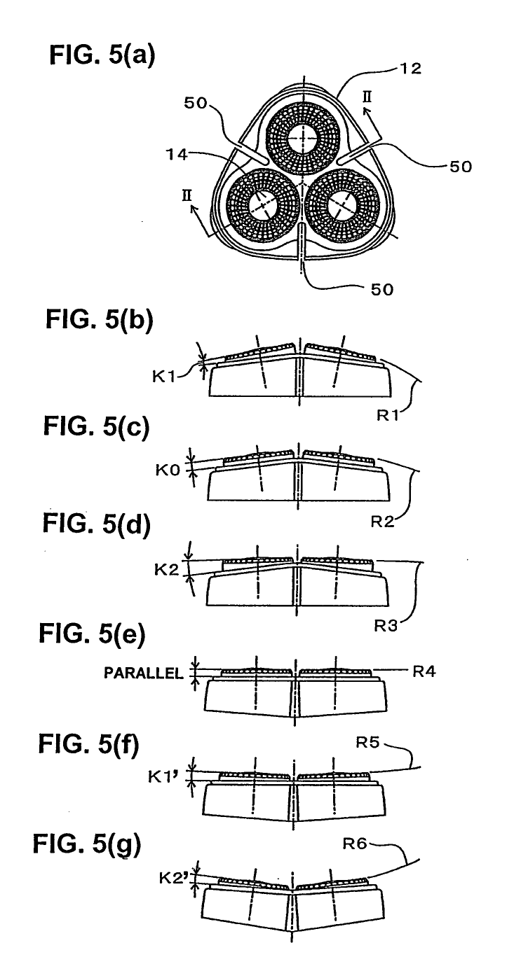

FIG. 1 shows a shaver according to one embodiment of the present invention, FIG. 2 shows a vertical cross-section of the shaver head of the shaver of FIG. 1, FIG. 3 shows a vertical cross-section of one cutter unit that comprises an outer cutter and an inner cutter, FIG. 4(a) is a top view of the outer cutter frame of the shaver of FIG. 1, and FIGS. 4(b)-4(d) are side views thereof. FIG. 5(a) is a top view of the outer cutter frame in which outer cutters are installed, and FIGS. 5(b)-5(g) are side views thereof. FIG. 2 is a cross-section taken along the lines II-II in FIG. 5(a).

In FIG. 1, the reference numeral 10 refers to a shaver main body, and 12 is a shaver head. The shaver head 12 is detachably attached to the upper part of the shaver main body 10 or is attached to the upper part of the shaver main body 10 so that it is opened and closed. To this shaver head 12, three sets of cutter units 18 each comprising, among others, an outer cutter 14 and an inner cutter 16 (described subsequently), are attached. The centers of three outer cutters 14 that correspond to the three cutter units 18 are located at the apexes of an equilateral triangle.

The shaver head 12 has an outer cutter frame 20 (FIG. 1) that can open and close (openable) upward relative to the shaver main body 10 or that can be attached and detached (detachable) with respect to the shaver main body 10. The outer cutters 14 are installed in three outer cutter mounting holes 22 formed in the outer cutter frame 20. The cutter units 18 that respectively include the outer cutters 14 are urged upward; in other words, the outer cutters are urged in a direction that the outer cutters 14 protrude upward.

Each outer cutter 14 is made of metal sheet formed into a substantially shallow topped bowl or cylinder that is upwardly convex (see FIGS. 2 and 3). The top portion of the outer cutter 14 is circular, and a substantially circular opening is formed in the center of this circular top portion so that an outer cutter cover 24 is secured in this opening from above. An engagement recess 26 is formed in the bottom of the outer cutter cover 24; and in to this engagement recess 26, the tip of the inner cutter 16 is engaged so that axial wobble of the inner cutter 16 is prevented.

In the circular top portion of the outer cutter 14 shown in FIG. 3, a single ring-shaped groove 28 is formed so that it is centered on the center axis x that is, when seen from above, a center of rotation of the inner cutter 16; and as a result, a pair of internal and external ring-shaped outer cutter thin layer portions are formed so that the internal and external thin layer portions sandwich the ring-shaped groove 28 in between. The outer surfaces of these outer cutter thin layer portions make skin contacting surfaces, while the inner surfaces thereof form inner cutter tracks 30a and 30b in which the cutter blades of the inner cutter slide.

In the outer cutter 14, numerous long slit-shaped hair introduction openings 32 (see FIGS. 1 and 5(a) are formed, in substantially the radial direction, so that the hair introduction openings 32 cross the thin layer portions from the center axis x thereof (see FIGS. 2 and 3). The lower surfaces of ribs 34 that remain between adjacent hair introduction openings 32 in the outer cutter thin layer portions constitute outer cutter blades that work together with the inner cutter 16 to cut the hair. Thus, the top portion of each outer cutter forms a shaving portion

The outer surface of the top portion of each outer cutter 14, that is, the outer surfaces of the ribs 34, are positioned on a plane which is perpendicular to the center axis x (the center axis x being a perpendicular line), as seen from FIGS. 2 and 3. In other words, the outer surfaces of the ribs 34 are flat.

The inner surface of the top portion (or thin layer portion) of each outer cutter 14 (that is, the bottom surfaces of the ribs 34) respectively constitute inner cutter tracks (ring-shaped tracks) 30a and 30b. The inner surfaces (bottom surfaces) of these inner cutter tracks 30a and 30b ride on a plane y shown in FIG. 3 that is perpendicular to the center axis x, as seen from below (from the inside). This plane y coincides with the bottom surfaces of the ribs 34 of the outer cutter. These inner surfaces of the outer cutter are polished by a grindstone, thus cutting edges are formed along the lower edges of the ribs 34.

The inner cutter 16 has a hub unit 36, made of a resin, opening downward in substantially conical shape, and numerous cutter bodies 38 are secured at equal intervals in the circumferential direction of the hub unit 36 to surround the hub unit 36. The cutter bodies 38 can be connected in a ring shape to form a single piece. Each of the cutter bodies 38 has an upper part that is divided in a two-pronged shape; and two cutter blades 40a and 40b, which are the divided parts, slide in and against the inner cutter tracks 30a and 30b, respectively, from below. The upper edges of these cutter blades 40a and 40b from cutting edges or blade edges, which are polished horizontally along the above-described plane y.

As seen from FIG. 3, the hub unit 36 has an engagement hole 42 of a square shape, when seen from below (or in horizontal cross-section), so that it opens downward; and into this engagement hole 42, a drive shaft 44, which protrudes out from the shaver main body 10, engages. In the upper end of this drive shaft 44, a plate-shaped engagement head 46 is formed, and this engagement head 46 is engaged with the engagement hole 42 of the hub unit 36 of the inner cutter 16 from below. The drive shaft 44 is rotationally driven by a motor (not shown), which is housed inside the shaver main body 10, and rotates the inner cutter 16.

The drive shaft 44 has a return propensity in an upwardly protruding direction due to a return spring 44A (see FIG. 2) that pushes the inner cutter 16 upward. As a consequence, the cutter blades 40a and 40b of the inner cutter 16 are elastically pushed in and against the inner cutter tracks 30a and 30b of the outer cutter 14 from below. The outer cutter 14, moreover, is formed with a flange 48 that protrudes outwardly from the bottom outer circumference, and this flange 48 engages the interior of the outer cutter mounting hole 22 of the outer cutter frame 20 from below. As a consequence, the cutter unit 18 that is comprised of the outer cutter 14 and the inner cutter 16 can sink downward (or is depressed), exhibiting elasticity, relative to the outer cutter frame 20. In other words, the upward return force from the return spring 44A of the drive shaft 44 generates an outer cutter upward pushing spring load that pushes the outer cutter 14 upward.

Next, the outer cutter frame 20 will be described with reference to FIGS. 1, 4, and 5.

The outer cutter frame 20 is a substantially triangular shape when seen from above. The portions of the vicinity of the three apexes of the substantially triangle outer cutter frame 20 are formed into a circular arc shape so as to surround the cutter units 18, and the outer circumferences are bent downward. In this outer cutter frame 20, three outer cutter mounting holes 22 into which the three outer cutters 14 are inserted are formed at positions constituting the apexes of an equilateral triangle, and three slits 50 are respectively formed between adjacent two outer cutter mounting holes 22 so that, as best seen from FIG. 5(a), each of the slits 50 advances inwardly from the outer circumference between two outer cutter mounting holes 22. In other words, in the shown embodiment, each of three slits 50 is formed from the side wall to the top surface of the outer cutter frame 20, starting from the lower edge of the side wall of the outer cutter frame 20 to substantially the middle point between the upper edge of the side wall to the center of the outer cutter frame 20, so that the slits 50 constitute a tilt-allowing portion or means (or bend-allowing portion or means) that allows the portions surrounding the outer cutters 14 to tilt (or bend).

With this outer cutter frame 20, as will be described subsequently, three areas of the lower surfaces A in the circular arc shaped corners of the triangle outer cutter frame 20 (see FIG. 4(a)) are brought into contact with the shaver main body 10 so as to make support points. When the central area of the outer cutter frame 20 is pressed downward, the outer cutter frame 20 bends so that the central area is depressed. The outer cutter frame 20, then, can return to the condition shown in FIG. 2 by the elasticity of the outer cutter frame 20 itself, by the return springs 44A installed in the drive shafts 44, and by an outer cutter upward pushing spring 56 described subsequently, when the pressing force is removed. In other words, by FIG. 4(b) it is shown that the outer cutter frame 20 is in a free condition in which no external force applied thereto; and in this situation, the outer cutter mounting holes 22 (or a plane defined by each cutter mounting holes 22) tilt toward the outer circumference so that they incline outwardly at an angle B0 from the center of the outer cutter frame 20. The tilt plane of the outer cutter mounting holes 22 in this situation is indicated by the reference symbol B3.

When, as shown in FIG. 4(c), a downward external force F1 is applied on near the center of the outer cutter frame 20, the outer cutter frame 20 tilts or bends with a help of the slit(s) 50, and such central area descends with the vicinities of the circumferential edge lower surfaces A as support points or center of tilting or bending, and the outer cutter mounting holes 22 are positioned substantially horizontal as indicated by angle B1.

When the downward external force intensifies and becomes F2, then as shown in FIG. 4(d), the outer cutter frame 20 further tilts or bends with a further help of the slit(s) 50, the central area of the outer cutter frame 20 descends and is depressed, so that the angle of the outer cutter mounting holes 22 is inverted to take the angle B2.

The above-described outer cutter frame 20 is installed in the shaver main body 10 in such a manner as illustrated in FIG. 2. In other words, a frame member 10A is fitted on the upper end of the shaver main body 10, and an inner bottom plate 10B is provided on this frame member 10A to cover it. The frame member 10A is in contact with the outer cutter frame 20 at support points A which are located at three locations (see FIG. 4(a)) on the outer cutter frame 20 as described above and is separated from the circumferential edge of the outer cutter frame 20 except at these support points A. In other words, three outer cutter frame clearances 20a are respectively provided between the frame member 10A and the inner bottom plate 10 and below the above-described three slits 50, so that portions of the outer cutter frame near the respective slits 50 can be lowered into the clearances 20a; and the central area of the outer cutter frame 20 is able to move up and down by the elasticity of the outer cutter frame 20 itself and to the elasticity of the return spring 44A and outer cutter upward pushing spring 56, etc.

Three of the above-described drive shafts 44 pass through the inner bottom plate 10B. The inner bottom plate 10B has, as seen from FIG. 2, raised portions that are positioned with gaps with respect to the outer cutter frame 20 in the vicinity of positions facing the support points A of the outer cutter frame 20. Inside these gaps, three erected portions 10C′ of a flat spring 10C, which is secured to the lower surface of the inner bottom plate 10B, are located. The upper ends 10C″ of the erected portions 10C′ of the flat spring 10C, which are positioned on the horizontally outer sides of the outer cutter mounting holes 22 of the outer cutter frame 20, are bent in a U-shape (lateral U-shape) and engaged with concavities 20A formed in the inner surface of the outer cutter frame 20. In other words, the upper ends 10C″ of the erected portions 10C′ of the flat spring 10C are respectively engaged with the concavities 20A which are formed in the inner circumferential surface of the outer cutter frame 20 and near the three support points A. The outer cutter frame 20 is thus held on the shaver main body 10 by the three erected portions 10C′ of the flat spring 10C and three support points A. Instead of the above described flat spring 10C, three flat springs (10C) respectively having erected portions (10C′) with the upper ends (10C″) engaged with the concavities (20A) can be employed.

As seen from FIG. 2, the outer cutter frame 20 is supported from below by an outer cutter frame holder 52, and this outer cutter frame holder 52 is in turn supported by an inner cutter holder 54. The outer cutter frame holder 52 has projections 52a formed so as to erect for supporting the outer cutter frame 20 at a plurality of locations in the circumferential direction. The inner cutter holder 54 is held by a knob 58, which is connected to the center part 20B of the outer cutter frame 20, with the outer cutter upward pushing spring 56 in between.

More specifically, the knob 58 passes through the center of the inner cutter holder 54 and is prevented from being separated from the inner cutter holder 54 by a C-ring 58a. Externally-threaded screw is formed on the tip portion of the knob 58 so that it engages an internally-threaded screw 20C that is securely inserted in the outer cutter frame 20.

Accordingly, when the knob 58 is screwed into the internally-threaded screw 20C, the outer cutter frame holder 52 and the inner cutter holder 54 are pressed by the spring pressure of the outer cutter upward pushing spring 56 and held in the outer cutter frame 20.

The outer cutter frame holder 52 is provided such that the inside of the center part 52d thereof is movable downward with a certain play relative to the center part 20B of the outer cutter frame 20, and the circumferential edge part 52c of outer cutter frame holder 52 is supported by the upper surface of the inner cutter holder 54.

Three inner cutters 16 are commonly mounted, so as to be movable with a certain play, on the inner cutter holder 54. More specifically, openings 54a into which the hub units 36 of the inner cutters 16 are inserted are formed in the inner cutter holder 54; and the inner cutters 16 are held in the inner cutter holder 54 by engagement between pawls 54b of the inner cutter holder 54 and expanded-diameter portions 36a of the hub units 36 of the inner cutters 16. In this structure, the pawls 54b protrude in the inner radial direction (or protrude inwardly) from the inner circumferential edge of the openings 54a of the inner cutter holder 54, and the expanded-diameter portions 36a are formed outwardly at the lower edges of the hub units 36 of the inner cutters 16. The outer cutter frame holder 52 is, as described above, elastically supported in the center part of the outer cutter frame 20 by the inner cutter holder 54, knob 58, and outer cutter upward pushing spring 56.

The action of the outer cutter frame 20 in the shaver described above of the shown embodiment will be described below with reference to FIGS. 5(a) through 5(g).

In the assembled condition of the shaver head 12 or when the shaver is not in use, the upper surface of the outer cutter frame 20 is, as seen from FIG. 4(b), tilted so that the center part 20B (see FIG. 2) thereof is higher than the outer circumference portion thereof. In this situation, the tilt angle of the upper surface of the outer cutter frame 20 relative to a horizontal plane is, as shown in FIG. 4(b), B0; and the outer surface of the top faces of the outer cutters 14 are parallel to the thus tilted upper surface of the outer cutter frame 20 as shown in FIG. 5(c); and thus, the angle K0 subtended by the tilt angle B0 of the outer cutter frame 20 and the outer cutters 14 is 0°. R2 in FIG. 5(c) shows the concave curved surface of the skin to be shaved.

FIG. 5(b) shows a situation in which the concave curved surface of the skin is smaller than at the time represented in FIG. 5(c) (when the curvature is greater). In this case, the tilt or angle of the outer cutter frame 20 is unchanged, and only the outer cutters 14 tilt outwardly, along the skin curved surface R1, so that the tilt angle of the outer cutters 14 relative to the outer cutter frame 20 becomes K1.

In the situation of FIG. 5(d) in which the curvature of the concave curved surface R3 of the skin is smaller than in FIG. 5(c), the tilt or angle of the outer cutter frame 20 is unchanged, and only the outer cutters 14 tilt (inwardly) at a tilt angle K2.

In the situation of FIG. 5(e), the shaver is brought up against a comparatively flat skin surface R4 (a cheek, for instance). The center area of the outer cuter frame 20 is pressed by the skin surface R4; and as a result, the outer cutter frame 20 tilts or bends with a help of the slit(s) 50, and the upper surface of the outer cutter frame 20 becomes substantially parallel with the top faces of the outer cutters 14.

FIG. 5(f) shows a situation that shaving is performed on the skin (the chin, for instance) in which the curvature of the convex curved surface R5 is relatively large and opposite from the situation of FIG. 5(b). In this situation, the outer cutter frame 20 further tilts or bends with a further help of the slit(s) 50, so that the tilt angle of the outer cutters 14 relative to the outer cutter frame 20 becomes K1′.

FIG. 5(g) illustrates a case that the shaving is performed on the curved surface R6 that is of greater convex compared to FIG. 5(f) with the curvature even smaller. In this situation, the outer cutter frame 20 even further tilts or bends with an even further help of the slit(s) 50, so that the tilt angle of the outer cutters 14 relative to the outer cutter frame 20 is K2′ that is greater than the tilt angle K1′ in FIG. 5(f).

In the structure of the above-described embodiment, the range of the tilt angle of the outer cutters 14 relative to the outer cutter frame 20 is K1 to K2 as shown in FIGS. 5(b) to 5(g), and the outer cutter frame 20 can tilt with an angle of B0 to B2 as diagrammed in FIGS. 4(b) to 4(d). As a result, tilting of the outer cutters 14 becomes possible for a total range of (K1+B0) to (K2′+B2). Accordingly, the shaver has broadened contact surface areas of the outer cutters relative to skin irregularities, thus, the shaver has an enhanced outer cutter utilization efficiency and provides an improved shaving feel. Furthermore, the circumferential edges of the outer cutters 14 are prevented from biting into the skin by the surface B3 (see FIG. 4(b)) of the outer cutter frame 20, and thus deep shaving is prevented.

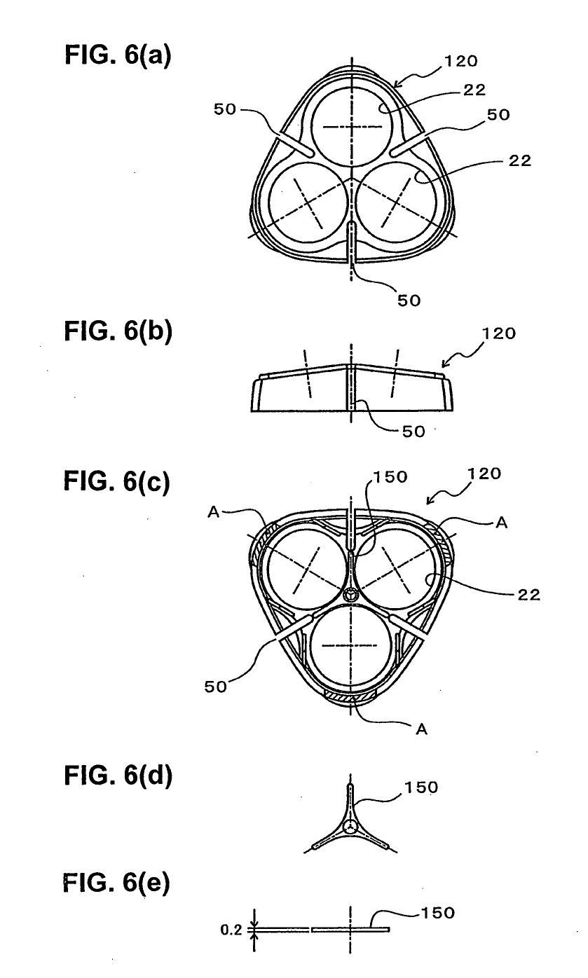

FIGS. 6(a) through 6(e) show another example of the outer cutter frame of the present invention. FIG. 6 (a) is a top view of the outer cutter frame, 6(b) a side view thereof, and 6(c) a bottom view thereof. FIG. 6(d) is a top view of a flat spring used in this embodiment, and 6(e) is a side view of this flat spring. In the outer cutter frame 120 of this example, the durability of the outer cutter frame 120 is higher than that of the previously described outer cutter frame, and the freedom of elastic force setting is made larger.

More specifically, in this example of FIGS. 6(a) through 6(e), a substantially three-pronged shape flat spring 150, which extends from the center of the outer cutter frame 120 to three areas that are respectively between adjacent outer cutter mounting holes 122, is secured in the inner central surface of the outer cutter frame 120. This flat spring 150 is secured to the inner surface of the outer cutter frame 120 by thermal bonding or by an adhesive or the like, so that damages resulting from fatigue when the center part of the outer cutter frame 120 is repeatedly pushed down is prevented, thus increasing the durability, and increasing the range of up and down movement of the center part of the outer cutter frame 120.

The flat spring 150 preferably is made of, for instance, a thin stainless steel sheet that has outstanding springiness. A thin sheet having a thickness of 0.2 mm, for instance, is very suitable. In FIGS. 6(a) through 6(c), those parts of the shaver that are the same as in the above-described embodiment are designated with the same reference symbols, and no description thereof is provided. The diagonally hatched areas in FIG. 6(c) are portions that constitute the support points A.

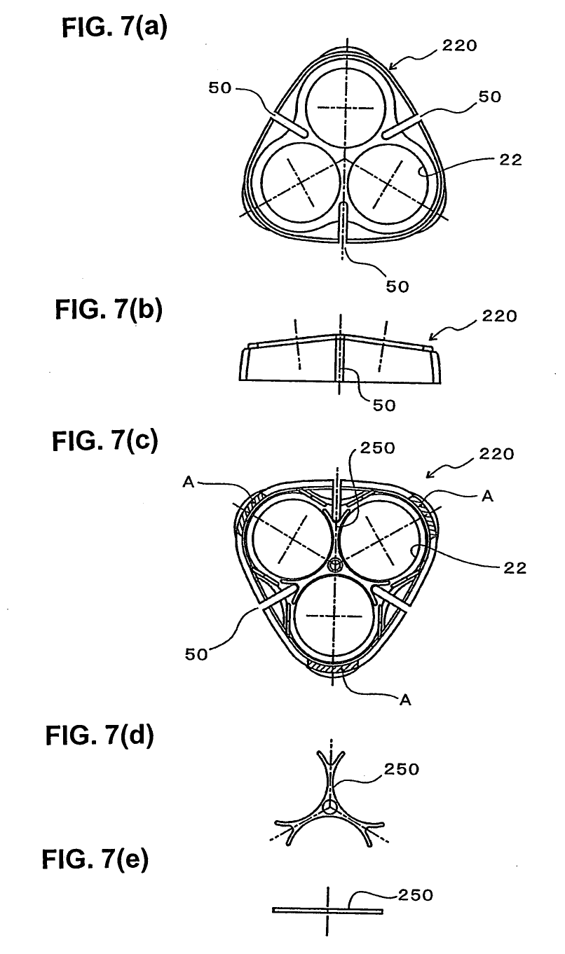

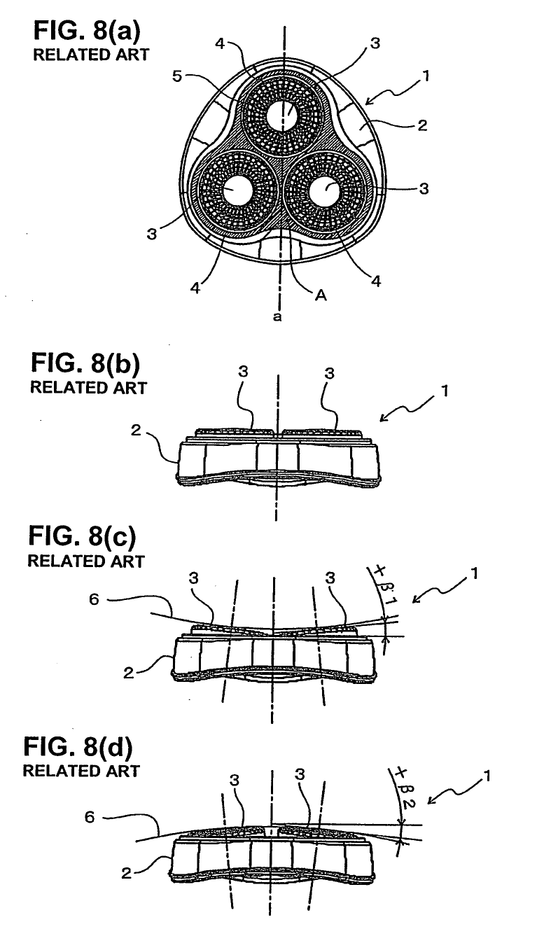

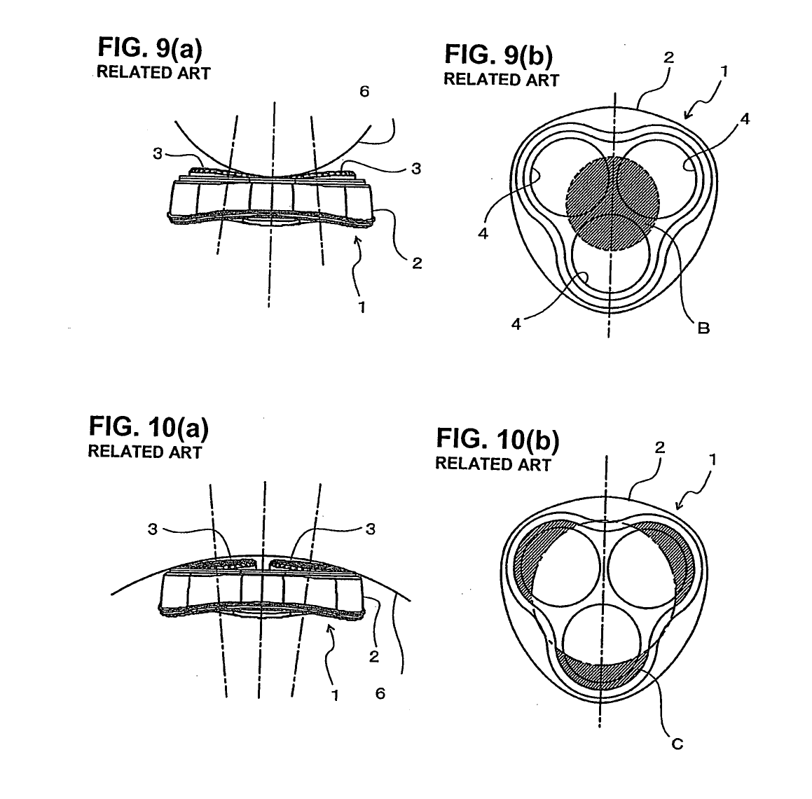

FIGS. 7(a) through 7(e) show still another example of the outer cutter frame of the present invention. FIG. 7(a) is a top view of the outer cutter frame, 7(b) a side view thereof, and 7(c) a bottom view thereof. FIG. 7(d) is a top view of a flat spring used in this example, and FIG. 7(e) is a side view of this flat spring. In this example, the flat spring 250 has a different shape from that of the flat spring 150 in the example shown in FIGS. 6(c) through 6(e).

More specifically, in the flat spring 250 used in the outer cutter frame 220, the three tip ends are bifurcated; in other words, the tip ends of the flat spring 150 described above are each divided into a two-pronged shape, so that the tip ends extend along the outer circumferences of the outer cutter mounting holes 22 formed in the outer cutter frame 220. With this flat spring 250 having bifurcated tip ends, the area of contact between the flat spring 250 and the inner surface of the outer cutter frame 220 is enlarged, and the effectiveness achieved by securing the flat spring 250 is enhanced. In FIGS. 7(a) through 7(e), those parts that are the same as those of FIGS. 6(a) through 6(e) are designated with the same reference symbols, and no further description thereof is provided.

1. A rotary electric shaver comprising:
a shaver main body housing therein a motor,
an outer cutter frame mounted on said shaver main body,
an outer cutter provided in an outer cutter mounting hole formed in said outer cutter frame, an outer surface of said outer cutter providing a skin contacting surface, and
an inner cutter that rotates while being pressed against an inner surface of said outer cutter and has cutter bodies for cutting hair entering hair introduction openings formed in said outer cutter; wherein
said outer cutter is provided so as to be tiltable relative to said outer cutter frame, and said outer cutter frame is provided so as to be tiltable relative to said shaver main body.

2. The rotary electric shaver according to claim 1, wherein
said outer cutter frame is formed with a plurality of outer cutter mounting holes,
a plurality of outer cutters are respectively provided in said outer cutter mounting holes, and
bend-allowing means are provided between adjacent said outer cutter mounting holes in said outer cutter frame, thus allowing portions of said outer cutter frame surrounding said outer cutters to be tiltable.

3. The rotary electric shaver according to claim 2, wherein said bend-allowing means are slits extending from outer circumferences of said outer cutter frame to between adjacent outer cutter mounting holes.

4. The rotary electric shaver according to claim 2 wherein said outer cutter frame is provided with three outer cutter mounting holes for respectively mounting therein three outer cutters, said outer cutter mounting holes being formed at equal intervals in a circumferential direction of said outer cutter frame.

5. The rotary electric shaver according to claim 4, wherein
said outer cutter frame is provided with three slits provided at equal angles of 120° apart,
said outer cutter frame is attached to said shaver main body at circumferential portions of said outer cutter frame between adjacent slits, and
a center part of said outer cutter frame is formed so as to be depressible.

6. The rotary electric shaver according to claim 3 or 5, wherein
outer circumferential lower portions of said outer cutter frame which are between adjacent slits are in contact with said shaver main body so as to make support points, and
projections arising from said shaver main body side and near said support points are engaged with an outer circumferential inner surface of said outer cutter frame.

7. The rotary electric shaver according to claim 1, wherein said outer cutter is provided so as to be tiltable and depressible relative to said outer cutter frame.

8. The rotary electric shaver according to claim 7, wherein an outer cutter upward pushing spring load is set to be smaller than an outer cutter frame upward pushing spring load.

9. The rotary electric shaver according to claim 2, wherein a flat spring having a plurality of erected portions that respectively erect on outer sides of said outer cutter mounting holes is provided in said outer cutter frame.
